(19) United States
(12) Patent Application Publication
(10) Pub. No.: US 2026/0207433 A1
(43) Pub. Date: Jul. 23, 2026

(54) PILL SWALLOWING ASSIST BOTTLE DEVICE

(71) Applicant: Hervina DOSANJH, Etobicoke (CA)

(72) Inventor: Hervina DOSANJH, Etobicoke (CA)

(21) Appl. No.: 19/133,009

(22) PCT Filed: Dec. 1, 2022
(86) PCT No.: PCT/CA2022/051761

§ 371 Date: May 27, 2025

Related U.S. Application Data
(63) Continuation-in-part of application No. 17/927,721, filed on Nov. 24, 2022, now Pat. No. 11,944,591.
Application No. 17/927,721 is a continuation of application No. PCT/CA2021/050697, filed on May 21, 2021.
Application No. PCT/CA2021/050697 is a continuation-in-part of application No. 16/882,674, filed on May 25, 2020, now Pat. No. 11,160,729.

(51) Int. Cl. A61J 7/00; B65D 23/12; B65D 47/06

(52) U.S. Cl. CPC A61J 7/0038; A61J 7/0046; A61J 7/0061; B65D 23/12; B65D 47/065

(57) ABSTRACT

A pill swallowing assist bottle device is disclosed. The bottle device includes a pill straw which has a channel that may receive a pill into an upper opening. The bottle device may have an inner cavity for holding a liquid. A lower portion of the pill straw may be received into the inner cavity and the bottom end of the pill straw may have one or more openings that prevent the pill from exiting the channel and also allow liquid to enter the channel of the pill straw. By reducing the volume of the inner cavity, the pill and liquid may be propelled within the channel to exit the pill straw and pass into a user's mouth and in this way assist the user with swallowing a pill.

### CROSS-REFERENCE TO RELATED APPLICATIONS

This application is a continuation-in-part of U.S. Utility Patent Application Ser. No. 17/927,721 with a 371(c) date of Nov. 24, 2022, which is a National Phase Entry Under 35 U.S.C. 371 of international PCT Patent Application Serial No. PCT/CA 2021/050697 filed on May 21, 2021 by Hervina DOSANJH designating the United States, which is a continuation-in-part and claims the benefit of U.S. Utility Patent Application Ser. No. 16/882,674 filed on May 25, 2020 (now U.S. Utility U.S. Pat. No. 11,160,729 issued on Nov. 2, 2021). The entire contents of each of the aforementioned applications are incorporated by reference herein.

### FIELD

The present invention relates in general to drink bottles, and, more specifically, to pill swallowing assist bottle devices.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND

A fluid bottle, or water bottle, is a container used for holding liquids, such as water or other beverages, for consumption. The use of a fluid bottle allows a user to drink and transport the beverage contained within from one place to another. Such fluid bottles are often made from plastic, glass, or metal, and are made available in a variety of shapes, sizes, and compositions. For example, a fluid bottle may be designed as a soft-plastic, disposable bottle having a pop-cap or a screw-cap for easy use and low cost. As another example, a fluid bottle may be shaped as a hard-plastic or metal, reusable bottle having a removably attached lid with an opening for pouring or drinking the beverage itself. Such fluid bottles may be more expensive, though are resilient enough to be cleaned, refilled, and used for a long period of time.

Reusable fluid bottles and their components tend to be made from some combination of high-density polyethylene (HDPE), low-density polyethylene (LDPE), copolyester, polypropylene, stainless steel, or aluminum. Such materials provide the advantages to the fluid bottle of being durable, light weight, dishwasher safe, and retaining minimal odor and taste from previous beverages stored therein. Some fluid bottles may further incorporate a plastic resin or epoxy liner layer between the outer material of the bottle and the contents within. Other fluid bottles may even incorporate a thermal insulation layer to maintain the temperature of the beverage.

A pill, or tablet, is a generally solid oral dosage form of some composition, which may be a pharmaceutical mixture, a homeopathic composition, a supplement, or any other material desired to be ingested without chewing. Pills are most often prepared in the form of rounded discs, cylindrical capsules, and even angular shapes that are meant to be swallowed by an action that avoids the user choking on or inhaling the pill. Such swallowing action, though, may often be difficult to perform, and a number of users have chronic difficulty swallowing pills for reasons as varied as the large size of the pill, poor swallowing technique, physiological limitations, or even emotional or mental inhibitions.

To overcome such difficulties a number of techniques have been implemented that aid in the swallowing action. One such technique is to chop up or grind up the pill and mix the ingredients with food or water. Such a technique, though, has the negative effect of reducing the amount of the composition actually ingested, diluting the composition into the food or water, and reducing the ability for the composition to pass from the gastrointestinal tract into the bloodstream.

Another technique often used is to swallow the pill whole with the assistance of a drink of some fluid. This technique employs the advantage of lubricating both the pill and the upper gastrointestinal tract, though is not the most effective method for swallowing. Some downsides to this technique involve partially dissolving the pill before it fully enters the gastrointestinal tract, or even altering the physiology of the gastrointestinal tract, as in the case of too alkaline or too acidic fluids, and reducing the effectiveness of the composition.

A more modern and highly recommended technique is to place the pill in a user's oral cavity or in a specialized container, and then drink fluid through a straw to vacuum the pill into the gastrointestinal tract. Such a straw-assisted technique employs negative pressure generated by the sucking action to overcome the user's swallowing difficulties. When combined with the use of water as the primary drink fluid this technique is considered very effective, having few negative attributes.

There is a need in the art for swallowing assist bottle devices that may be carried by a user so as to provide the convenience of a water bottle while also incorporating a specialized component for aiding the user in swallowing pills.

### SUMMARY

According to an embodiment there is provided method of transferring a pill from a bottle device to a user's stomach. The bottle device may comprise a main body enclosing an internal cavity, the main body being deformable upon the application of one or more squeezing forces (which may be opposed inwardly directed compressive forces) to reduce a volume of the internal cavity. A lid portion may be secured to the main body and a pill straw may be secured to the main body lid. The spill straw may comprise a channel having an upper opening at an upper end through which a pill can be placed, and may further comprise a plurality of pill straw inlets proximate a lower end of said channel The pill straw inlets may be sized to hold the pill within the channel. the method may comprise: inserting a pill into the upper opening of the pill straw and into the channel, with the internal cavity containing a volume of liquid; placing a user's lips over the upper opening of the pill straw; and applying one or more squeezing forces to the main body to reduce the volume of the internal cavity of the device to propel a liquid located within the internal cavity through the plurality of pill straw inlets and propel the liquid along with the pill through the channel to exit from the opening and into a user's mouth, whereby the user swallows the pill and liquid simultaneously, thereby transferring the pill to the user's stomach.

The pill straw further may comprise a pill straw spout at the upper end of the channel when the main body of the device is squeezed the liquid is also propelled through the pill straw spout. The method may also comprise wherein before applying the one or more squeezing forces, with the bottle held upright, the user tilts their head downwards. The pill straw may be reversibly secured to the main body lid. The method may also comprise before step having the user's lips placed over the upper opening of the pill straw, inserting a volume of liquid into the internal cavity. The channel of the pill straw may have an interior diameter in the range of 0.5 to 1.0 cm. The internal cavity may have a volume of about 600 cm³ . During operation the liquid along with the pill may exit from the opening in a stream or jet of liquid.

According to another embodiment there is provided a swallowing assist bottle device, comprising: a main body enclosing an internal cavity, said main body being deformable upon the application of one or more squeezing forces (which may be opposed inwardly directed compressive forces) to reduce a volume of said internal cavity. A lid portion may be secured to the main body. A pill straw may be secured to the main body lid, the pill straw comprising a channel having an upper opening at an upper end through which a pill can be placed, and further comprise a plurality of pill straw inlets proximate a lower end of the channel, said pill straw inlets sized to hold the pill within the channel. In operation, a liquid may be inserted into the internal cavity, and a user's lips may be placed over the upper opening of the pill straw. Applying one or more squeezing forces to the main body of the device reduces the volume of the internal cavity to propel a liquid located within the internal cavity through the plurality of pill straw inlets and propel the liquid along with the pill in the channel, through the channel to exit from the upper opening and into a user's mouth. The user swallows the pill and liquid simultaneously, thereby transferring the pill to the user's stomach.

The device may be made from a deformable plastic. The main body may be made from at least one of the following materials: silicone, polyethylene terephthalate (PET), high density polyethylene (HDPE) or low density polyethylene (LDPE). The lid portion is made from a hard plastic. The pill straw may be made from silicone, polyethylene terephthalate (PET), high density polyethylene (HDPE) or low density polyethylene (LDPE). The pill straw may be secured to the main body lid with a sealing mechanism. The securing mechanism may comprise a rubber seal device. The pill straw may comprise a lower region surface area proximate the lower end of the channel and wherein the area of the plurality of pill straw inlets may comprise at least 50% of the lower surface region area. The channel may have an interior diameter in the range of 0.5 to 1.0 cm. The internal cavity may have a volume of about 600 cm³ . During operation the liquid along with the pill may exit from the opening in a stream or jet of liquid.

In another embodiment, there is provided a swallowing assist bottle device, comprising: a main body enclosing an internal cavity; a lid portion secured to the main body; and a pill straw secured to and extending through the main body lid, said pill straw comprising a channel having an upper opening at an upper end through which a pill can be placed, and further comprises a plurality of pill straw inlets proximate a lower end of said channel, said pill straw inlets sized to hold the pill within the channel; and a volume reduction mechanism operable to reduce the volume of the internal cavity of the main body. In operation, when a liquid is inserted into the internal cavity, and a user's lips are placed over the upper opening of the pill straw; operating the volume reduction mechanism reduces a volume of the internal cavity to propel a liquid located within the internal cavity through the plurality of pill straw inlets and propel the liquid along with the pill in the channel, through the channel to exit from the upper opening and into a user's mouth, whereby the user swallows the pill and liquid simultaneously, thereby transferring the pill to the user's mouth. Also disclosed is a method of using this device comprising: inserting a pill into the upper opening of the pill straw and into the channel, with the internal cavity containing a volume of liquid; placing a user's lips over the upper opening of the pill straw; and activating the volume reduction mechanism to reduce the volume of the internal cavity of the device to propel a liquid located within the internal cavity through the plurality of pill straw inlets and into the channel to propel the liquid along with the pill through the channel to exit from the opening and pass into a user's mouth. The method may also include wherein before activating the volume reduction mechanism, with the bottle held upright, the user tilts their head downwards.

These and other advantages and features of the present invention are described herein with specificity so as to make the present invention understandable to one of ordinary skill in the art, both with respect to how to practice the present invention and how to make the present invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a dual spout pill storage and swallowing assist bottle device, as contemplated by the present disclosure;

FIG. 2 is a front perspective view of a dual spout pill storage and swallowing assist bottle device, as contemplated by the present disclosure;

FIG. 3 is a rear perspective view of a dual spout pill storage and swallowing assist bottle device, as contemplated by the present disclosure;

FIG. 4 is a left side elevation view of a dual spout pill storage and swallowing assist bottle device, as contemplated by the present disclosure;

FIG. 5 is a right side elevation view of a dual spout pill storage and swallowing assist bottle device, as contemplated by the present disclosure;

FIG. 6 is a top plan view of a dual spout pill storage and swallowing assist bottle device, as contemplated by the present disclosure;

FIG. 7 is a bottom plan view of a dual spout pill storage and swallowing assist bottle device, as contemplated by the present disclosure;

FIG. 8 is an isometric perspective view of a dual spout pill storage and swallowing assist bottle device with its pill straw spout extended, as contemplated by the present disclosure;

FIG. 9 is a left side elevation view of a dual spout pill storage and swallowing assist bottle device with its pill straw spout extended, as contemplated by the present disclosure;

FIG. 10 is a front perspective view of a dual spout pill storage and swallowing assist bottle device with its drinking spout cap disengaged from the drinking spout, as contemplated by the present disclosure;

FIG. 11 is an exploded component view of a dual spout pill storage and swallowing assist bottle device, as contemplated by the present disclosure;

FIG. 12 is a detailed view of a pill straw of a dual spout pill storage and swallowing assist bottle device, as contemplated by the present disclosure;

FIG. 13 is a detailed view of a pill straw and pill straw spout combination in drinking orientation of a dual spout pill storage and swallowing assist bottle device, as contemplated by the present disclosure;

FIG. 14 is a detailed view of a pill straw and pill straw spout combination in storage orientation of a dual spout pill storage and swallowing assist bottle device, as contemplated by the present disclosure;

FIG. 15 is an isometric perspective view of a drinking spout pill retainer insert of a dual spout pill storage and swallowing assist bottle device, as contemplated by the present disclosure;

FIG. 16 is a is an exploded component view of a bottle device, according to another embodiment; and

FIG. 17 is a schematic view of an alternate embodiment of a bottle device employing a plunger device as a volume reduction mechanism.

### DETAILED DESCRIPTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The dual spout pill storage and swallowing assist bottle device is intended to be carried by a user and provide a mobile source of fluids, as in the case of a fluid bottle. The device provides two distinct drinking spouts and is configured to allow a user to both drink from the bottle as normal and drink from the bottle in a way to assist the user with swallowing pills. To perform these dual functions the dual spout pill storage and swallowing assist bottle device comprises a standard drinking spout and a pill straw with a reversibly deployable spout incorporated into the lid of the device. By this design, the device may be used to drink fluids without hindrance as desired, and to also facilitate a straw-assisted vacuum swallowing of a pill when needed. The device may further comprise a storage compartment for carrying pills and other items, and may further comprise a pill retaining insert for the standard spout.

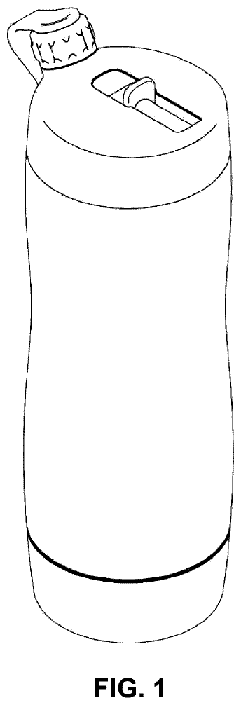

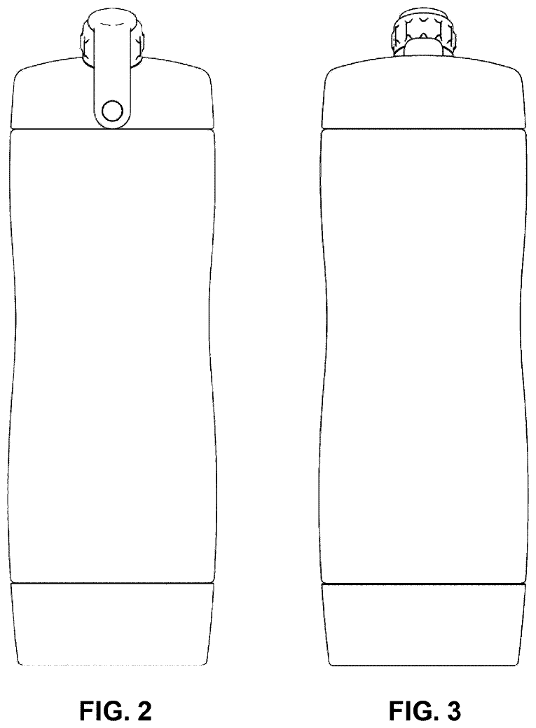

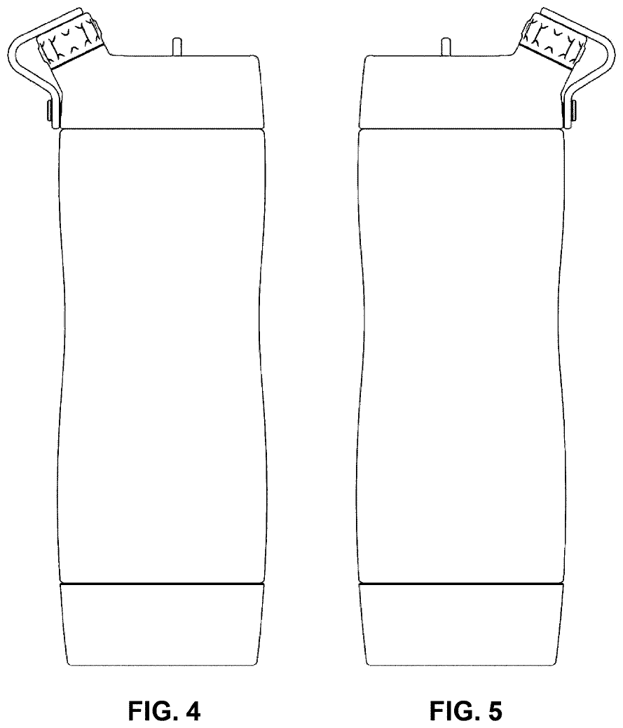

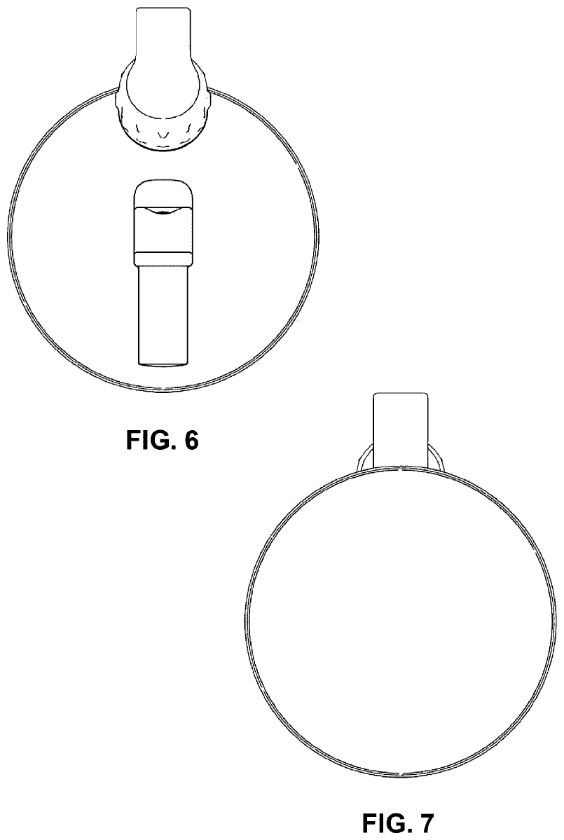

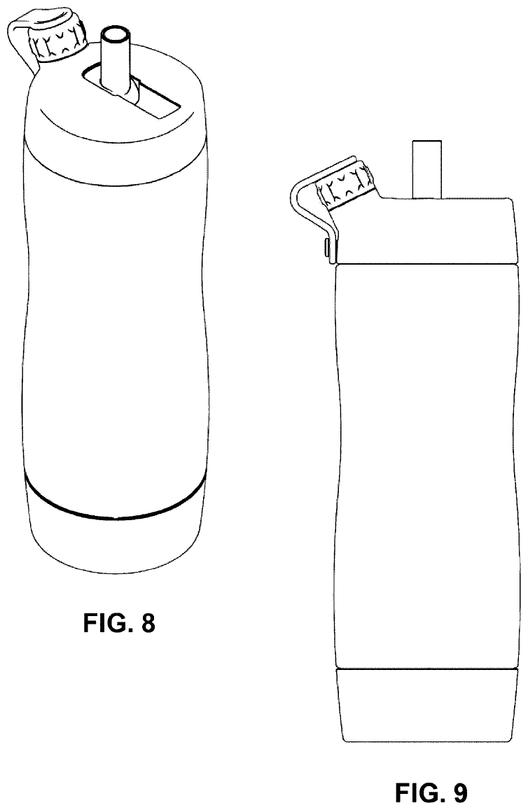

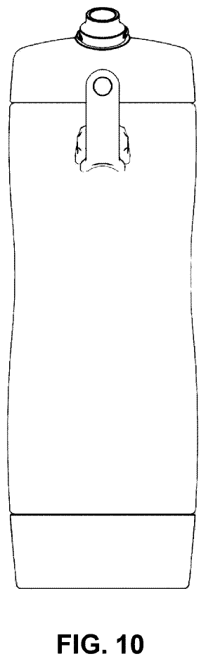

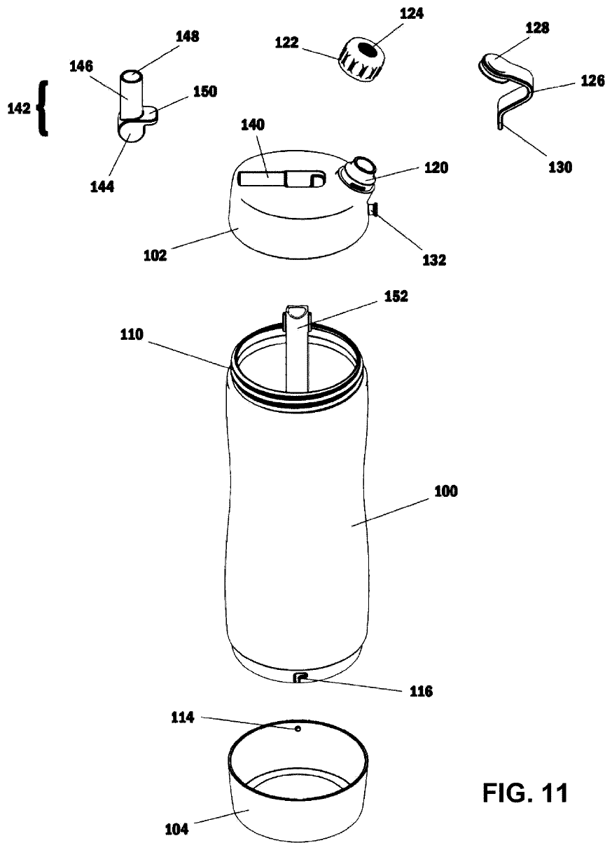

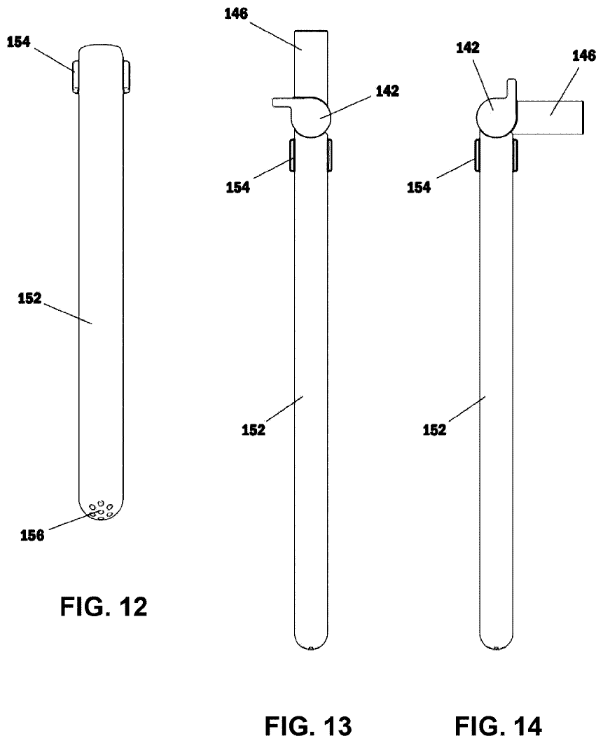

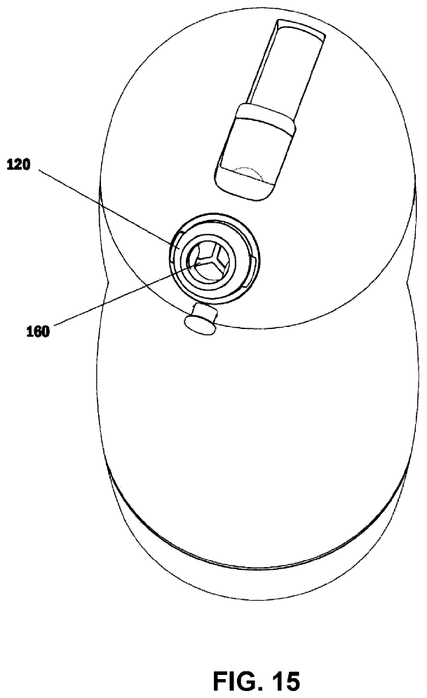

The illustrations of FIGS. 1-15 illustrate a dual spout pill storage and swallowing assist bottle device, as contemplated by the present disclosure. The device may comprise, generally, a main body 100, a main body lid 102, a drinking spout 120, and a pill straw 152 and pill straw spout 142 combination.

The main body 100 may comprise, generally, a cylindrical container having an open top, a closed bottom surface, a perimeter wall, and a central cavity. The closed bottom surface and perimeter wall may comprise a single layer of uniform material construction, or may comprise a multiple-layer construction consisting of multiple materials. In an embodiment comprising multiple materials the plurality of materials may include one material appropriate for providing structural support to the main body 100, another material appropriate for providing insulation to the main body 100, and another material appropriate for providing anti-microbial characteristics to the main body 100.

The main body 100 may further comprise a body to storage attachment 116 located near or at the bottom surface of the main body 100, and a body to lid attachment 110 located near or at the open top of the main body 100. The body to storage attachment 116 and body to lid attachment 110 may each comprise one half of any appropriate mechanism for attachment, though may each comprise different mechanisms for attachment depending on the particular embodiment of the device. By way of example, the body to storage attachment 116 may comprise one half of a slotted attachment mechanism while the body to lid attachment 110 may comprise one half of a screw-on mechanism.

The perimeter wall of the main body 100 may comprise a cylinder having a substantially consistent diameter from the open top of the main body 100 to the closed bottom of the main body 100. In some embodiments the perimeter wall of the main body 100 may, instead, have a varying diameter from one end to the other for aesthetic of functional purposes. The perimeter wall of the main body 100 may further comprise an integrated traction mechanism such as, for example, depressed finger grooves, an attached handle, or any other appropriate mechanism.

The main body lid 102 may comprise, generally, a disc-shaped cap having a closed top surface, an open bottom, a perimeter wall, and a central cavity. The closed top surface and perimeter wall may comprise a single layer of uniform material construction, or may comprise a multiple-layer construction consisting of multiple materials. In an embodiment comprising multiple materials the plurality of materials may include one material appropriate for providing structural support to the main body lid 102, another material appropriate for providing insulation to the main body lid 102, and another material appropriate for providing anti-microbial characteristics to the main body lid 102.

The main body lid 102 may further comprise a lid to body attachment located near or at the open bottom of the main body lid 102. The lid to body attachment may comprise one half of any appropriate mechanism for attachment complementary to the mechanism of attachment selected for the body to lid attachment 110. By way of example, in an embodiment wherein the body to lid attachment 110 comprises one half of a screw-on mechanism the lid to body attachment may comprise the complementary second half of the screw-on attachment mechanism. In this way the lid to body attachment and, thus, the main body lid 102, may be reversibly attached to the body to lid attachment 110 and the main body 100.

The main body lid 102 may further comprise a drinking spout 120, which may be any appropriate outcropping from the closed top surface of the main body lid 102, the perimeter wall of the main body lid 102, or a combination thereof. The drinking spout 120 may further comprise a central opening through its entire structure that creates a path from the central cavity of the main body lid 102 to the outer side of the device. By this design, the tilting of the device by a user for drinking may allow fluid to pass through the drinking spout 120 and into the user's oral cavity for normal drinking.

The main body lid 102 may further comprise a straw spout recess 140, which may be any appropriate indentation within the closed top surface of the main body lid 102 into which may be installed a pill straw spout 142. The pill straw spout 142 may comprise a structure having a straw spout hinge 144, a straw spout cylinder 146, a straw spout central opening 148, and a straw spout lever 150. The straw spout hinge 144 may be any appropriate hinge connecting the pill straw spout 142 to the straw spout recess 140 and allowing the pill straw spout 142 to articulate relative to the main body lid 102. By way of example, the straw spout hinge 144 may comprise a circular or disc-shaped protrusion that fits into a circular or disc-shaped receiver in the straw spout recess 140, which may allow the pill straw spout 142 to travel in an arc from zero degrees to ninety degrees relative to the closed top surface of the main body lid 102.

The straw spout cylinder 146 may comprise a hollow cylinder extending from the straw spout hinge 144, and the traveling in an arc from zero degrees to ninety degrees relative to the closed top surface of the main body lid 102 may cause the straw spout cylinder 146 to project upwards from the main body lid 102. The straw spout cylinder 146 and straw spout hinge 144 combination may further comprise a straw spout central opening 148, which may be aligned with an opening in the straw spout recess 140 when the pill straw spout 142 is articulated, that creates a path from the central cavity of the main body lid 102 to the outer side of the device. The pill straw spout 142 may further comprise a straw spout lever 150, which may be any appropriate tab or protrusion designed to provide traction or leverage on the pill straw spout 142 and facilitate its articulation by a user.

The main body lid 102 may further comprise a pill straw receiver attached within the central cavity of the main body lid 102 and aligned with the opening in the straw spout recess 140 and straw spout central opening 148 when the pill straw spout 142 is articulated.

The dual spout pill storage and swallowing assist bottle device may further comprise a pill straw 152, which may further comprise a straw to lid attachment 154 and a plurality of pill straw inlets 156. The pill straw 152 may comprise a hollow cylindrical shape having an open top and a closed bottom surface. The straw to lid attachment 154 may be attached near or at the open top of the pill straw 152 and may comprise one half of any appropriate mechanism for attachment. The pill straw receiver may comprise any appropriate mechanism for attachment complementary to the mechanism of attachment selected for the straw to lid attachment 154. By way of example, in an embodiment wherein the straw to lid attachment 154 comprises one half of a slotted attachment mechanism the pill straw receiver may comprise the complementary second half of the slotted attachment mechanism. In this way the straw to lid attachment 154 and, thus, the pill straw 152, may be reversibly attached to the pill straw receiver and the main body lid 102.

The plurality of pill straw inlets 156 may comprise a plurality of openings in the closed bottom surface of the pill straw 152 sufficient to allow for the passage of fluid when a vacuum is applied. By this design, a sucking action by a user for drinking may allow fluid to pass through the pill straw 152 and pill straw spout 142 and into the user's oral cavity for normal drinking. A pill placed into the pill straw 152 may be held within the device, and the sucking action by a user for drinking may allow fluid to pass through the pill straw 152 and pill straw spout 142 and into the user's oral cavity along with the pill for fluid-assisted swallowing.

The dual spout pill storage and swallowing assist bottle device may further comprise a drinking spout cap 122, which may be any cap appropriate for fitting over the drinking spout 120 of the selected embodiment. The drinking spout cap 122 may be attached to the drinking spout 120 by any appropriate mechanism such as, for example, a friction fit mechanism, a screw-on mechanism, a pop-fit mechanism, or other appropriate mechanism. The drinking spout cap 122 may further comprise a cap to arm attachment 124, which may be attached to an arm to cap attachment 128 of a spout cap arm 126. The spout cap arm 126 may further comprise an arm to lid attachment 130, which may be attached to a cap arm anchor point 132 attached on or integrated into the main body lid 102 or main body 100.

The spout cap arm 126 may comprise any appropriate flexible device for keeping the drinking spout cap 122 attached to the dual spout pill storage and swallowing assist bottle device while also allowing for the drinking spout cap 122 to be removably installed on the drinking spout 120. By way of example, the spout cap arm 126 may comprise a plastic, fabric, or leather strap, and the arm to cap attachment 128 may be glued, stitched, or pressed onto the cap to arm attachment 124 while the arm to lid attachment 130 may be glued, stitched, or pressed onto the cap arm anchor point 132. The cap arm anchor point 132 may be any attachment point appropriate for receiving the arm to lid attachment 130 such as, for example, a post, slot, button, or other similar mechanism.

In some embodiments the dual spout pill storage and swallowing assist bottle device may further comprise a storage component 104. The storage component 104 may comprise, generally, a disc-shaped cap having an open top, a closed bottom surface, a perimeter wall, and a central cavity. The closed bottom surface and perimeter wall may comprise a single layer of uniform material construction, or may comprise a multiple-layer construction consisting of multiple materials. In an embodiment comprising multiple materials the plurality of materials may include one material appropriate for providing structural support to the storage component 104, another material appropriate for providing insulation to the storage component 104, and another material appropriate for providing anti-microbial characteristics to the storage component 104.

The storage component 104 may further comprise a storage to body attachment 114 located near or at the open top of the storage compartment 104. The storage to body attachment 114 may comprise one half of any appropriate mechanism for attachment complementary to the mechanism of attachment selected for the body to storage attachment 116. By way of example, in an embodiment wherein the body to storage attachment 116 comprises one half of a slotted attachment mechanism the storage to body attachment 114 may comprise the complementary second half of the slotted attachment mechanism. In this way the storage to body attachment 114 and, thus, the storage compartment 104, may be reversibly attached to the body to storage attachment 116 and the main body 100.

The central cavity of the storage component 104 may comprise an open cavity to permit a user to place objects within the storage component 104. In some embodiments the central cavity of the storage compartment 104 may further comprise dividers or containers for storing various items separately from one another. By way of example, the central cavity of the storage component 104 may be intended to store a user's pills, and may be divided into seven compartments so that the user may store the pills needed for one week.

In some embodiments the dual spout pill storage and swallowing assist bottle device may comprise variations that remain within the spirit and scope of the present disclosure. By way of a first example, the drinking spout 120 may further comprise an insert receiver into which may be placed a drinking spout pill retainer insert 160. Such an insert may be permanently installed or removably installed by the user to convert the drinking spout 120 into a secondary pill swallowing assist device.

A pill placed on the drinking spout pill retainer insert 160 may be held within the drinking spout 120, and the tilting of the device by the user for drinking may allow fluid to pass through the drinking spout pill retainer insert 160 and into the user's oral cavity along with the pill. By this design, the user may employ a fluid-assisted swallowing technique instead of the vacuum suction technique facilitated by the pill straw 152 and pill straw spout 142 combination.

By way of a second example, the central cavity of the storage component 104 may comprise an undivided cavity for general storage of larger pills or secondary items while an additional divided storage container may be integrated into the perimeter wall of the main body 100.

The dual spout pill storage and swallowing assist bottle device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the dual spout pill storage and swallowing assist bottle device may be substantially constructed of one or more materials of silicone, plastic, acrylic, polycarbonate, steel, aluminum, brass, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the dual spout pill storage and swallowing assist bottle device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

According to another embodiment, there is provided a method of using the dual spout pill storage and swallowing assist bottle device of the present disclosure to transfer a pill to the stomach of a user. The method generally includes: placing a pill on top of a user's tongue (or in other embodiments, on the drinking spout pill retainer insert of the bottle device); placing the user's lips over the drinking spout of the bottle device to form a seal around the drinking spout; tilting the user's head back and squeezing the main body of the bottle device to propel a fluid contained within the main body into the user's mouth to allow the user to swallow the pill and fluid simultaneously thereby transferring the pill to the user's stomach. The drinking spout is configured and shaped such that placement of the user's lips across the drinking spout forms a tight seal to prevent air from being transferred into the mouth which is known to interfere with pill swallowing. The drinking spout is also configured and shaped such that when the main body is squeezed a constant force of liquid is propelled into the user's mouth to assist the user in swallowing the pill.

In an alternative embodiment, the pill straw and pill straw spout may be used to assist the user in swallowing the pill. In this embodiment, the pill straw spout is articulated upwards from the main body lid and a pill is placed inside the pill straw spout/pill straw. The user's head is then tilted downward towards the pill straw spout/pill straw of the bottle device. The user's lips may then be placed across the pill straw spout and the main body of the bottle device can be squeezed to propel liquid within the main body and the pill in the pill straw spout/pill straw upwards and into the user's mouth. The user can then swallow the pill and liquid simultaneously thereby transferring the pill to the user's stomach.

When inserting a pill into the channel of the pill straw at the top end, the pill may descend at least part way, if not entirely, due to gravity (if the bottle device is held/oriented in a generally upwards direction) down to the bottom end of the pill straw. When propelled through and out of the channel of the pill straw, the pill and liquid carrying the same, will have developed a reasonably high velocity—the magnitude of which will be dependent, in part on how large are the squeezing force(s) that are applied to the main body and also in part on the size of the cross-sectional area of the channel 1153 of pill straw 1152.

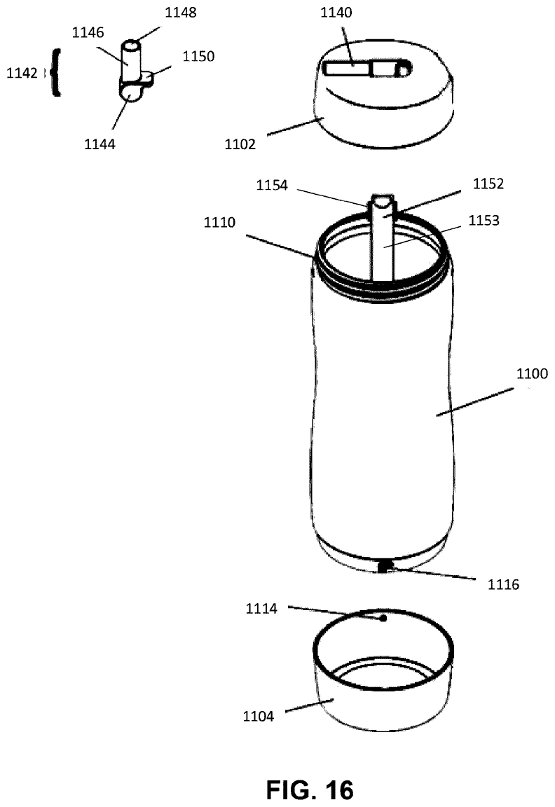

With reference to FIG. 16, a bottle device is shown which may be generally similar to the bottle device shown in FIGS. 1-11. The bottle device may comprise a main body 1100, a main body lid 1102 and a pill straw 1152 and pill straw spout 1142 combination. Main body 1100 may be generally similar to or substantially the same as main body 100 and may comprise a generally cylindrical container having an open top, a closed bottom surface, a perimeter wall, and a internal (or central) cavity.

In various embodiments the internal cavity may have a volume of about 200 cm³ , about 300 cm³ , about 400 cm³ , about 500 cm³ , about 600 cm³ , about 700 cm³ , about 800 cm³ , about 900 cm³ , or about 1000 cm³. Similar to main body 100, main body 1100 may further comprise a body to storage attachment 1116 located near or at the bottom surface of the main body 1100, for attachment of storage component 1104, which may be similar to storage compartment 104 described above. Storage component 1104 may further comprise a storage to body attachment 1114, similar to storage to body attachment 114, located near or at the open top of the storage compartment 1104

The pill straw 1152 and pill straw spout 1142 combination of the bottle device of FIG. 16 may be generally similar to, or substantially the same, as the pill straw 152 and pill straw spout 142 combination described above.

The pill straw spout 1142 may comprise a straw spout hinge 1144, a straw spout cylinder 1146, a straw spout central opening 1148, and a straw spout lever 1150 which may be generally similar to a straw spout hinge 144, a straw spout cylinder 146, a straw spout central opening 148, and a straw spout lever 150 described above. The main body lid 1102 may further comprise a straw spout recess 1140 (similar to straw spout recess 140), which may be any appropriate indentation within the closed top surface of the main body lid 102 into which may be installed pill straw spout 1142.

Pill straw 1152 may be generally similar to or the substantially the same as pill straw 152 and comprises a channel 1153 having an upper opening at an upper end and a lower opening at a lower opening through which a pill can be placed. Pill straw 1152 may further comprise a plurality of pill straw inlets (not shown in FIG. 16, but which may be generally similar to or substantially the same as pill straw inlets 156) proximate to a lower end of channel 1153 and sized to hold the pill in channel 1153.

The channel 1153 may be sized to receive a pill such that the channel 1153 has an internal diameter that is slightly larger than a width or length of the pill. In some embodiments, channel 1153 has a diameter of between 0.5 and 1 cm, or between 0.6 and 0.9 cm or between 0.7 and 0.8 cm. By providing a channel with such a circular shaped cross section and in particular having a relatively small diameter, during operation of the bottle device by for example squeezing the bottle to propel liquid from the internal cavity and a pill, through and out of the top end of the channel and into a user's mouth, a relatively narrow and focused jet/stream of liquid along with the pill may be discharged at a relatively high velocity from the end of the channel 1153. This may then assist in delivering the liquid and pill into the user's mouth—such as deep into a user's mouth and throat-which may increase the prospects of initiating an individual's natural swallow-reflex enabling the user to easily swallow the pill. Also, by restricting the size of the cross sectional of the channel, this will provide some level of restriction in the volume/rate of flow of liquid into the user's mouth, and may reduce the prospect of a user taking in too much liquid into their mouth and throat and may reduce the risk of the user gagging or choking as a result of too much fluid and the pill-being taken into the mouth and throat area of the user.

The plurality of pill straw inlets are located proximate to the lower end of channel 1153 and are configured such that a sufficient proportion of the lower end of channel 1153 is open to allow a sufficient volume and rate of flow of liquid from the internal cavity into channel 1153, to be able to propel a pill and liquid out the top end of channel 1153, without allowing a pill to exit channel 1153 at the lower end. In an embodiment, the plurality of pill straw inlets are configured such that about 40% or more of the lower end of channel 1153 is open, about 50% or more of the lower end of channel 1153 is open, about 60% or more of the lower end of channel 1153 is open, about 70% or more of the lower end of channel 1153 is open, about 80% or more of the lower end of channel 1153 is open or about 90% or more of the lower end of channel 1153 is open.

Whilst the plurality of pill straw inlets are shown in the FIGS. as circular, they may have any suitable shape such as square, triangular, oval or a slot shape as long as the inlets are able to allow a sufficient volume of liquid into the channel in order to propel the pill contained with the channel as described above and such that the inlets are not able to allow the pill to exit the lower end of the channel.

Pill straw 1152 further comprise a straw to lid attachment 1154 (which may be similar to attachment 154 described above). Attachment 1154 may be configured to provide a substantially air and liquid tight seal between pill straw 1152 and main body lid 1102, (or between the main body lid and the main body) such that when main body 1100 is squeezed by the application of one or more external squeezing forces, liquid or air within the internal cavity of main body 1100 will not leak/escape between main body lid 1102 and pill straw 1152 and liquid instead is all propelled into channel 1153 through the plurality of pill straw inlets as described above. The connection between pill straw and the main body lid may also be configured/secured so as to ensure that the pill straw stays in its longitudinal position relative to main body lid 1102. In order for a liquid to be able to adequately propel a pill through the channel and into a user's mouth, there should be a sufficient volume of liquid held within the internal cavity Preferably before activating the mechanism to propel the liquid and the pill through and out of the channel the internal cavity will be substantially or entirely filled with liquid so as to substantially or entirely eliminate the presence of air within the internal cavity. It is desirable during operation of the bottle device, that there is no air that is mixed with the liquid in the channel 1153 when the pill and liquid are being propelled through the channel to exit the upper opening so that there will be a consistent and uniform stream and focused jet of liquid that is propelled into the mouth of a user during use.

In some embodiments, attachment 1154 may comprise a seal or gasket, manufactured from a suitable material such as rubber. In an embodiment, attachment 1154 is a rubber seal device such as an O-ring that is retained within a groove of main body lid 1102. A portion of pill straw 1152 may be received within the O-ring to provide a substantially air and liquid tight seal between pill straw 152 and main body lid 1102.

In other embodiments, pill straw 1152 and main body lid 1102 are integrally formed.

In other embodiments, the bottle device of FIG. 16 may not include a hinged pill straw and pill straw spout combination, but instead may include a one-piece straw that may be substantially straight and/or curved at an upper end. The one-piece straw may comprise a channel (similar to channel 1153) having an upper opening at an upper end (through which a pill can be placed) and a plurality of pill straw inlets proximate to a lower end of the channel. The upper opening at the upper end of the channel may extend through an opening in main body lid 1102, whereby a user's lips are placed over the upper opening of the pill straw to receive a pill and liquid simultaneously from the channel. In such embodiments, the one-piece straw may include a way of/device for preventing flow of liquid through the channel when not in use, such as a valve positioned within the channel 1153 or a cap configured to fit over the upper opening of the channel of the straw.

Whilst in the embodiment shown in FIG. 16, main body lid 1102 does not include a drinking spout (similar to drinking spout 120) as described above, in other embodiments a separate drinking spout may be provided with the bottle device of FIG. 16 as described above.

In order to make the main body 100 or main body 1100 squeezable, it will be understood that there are a number of ways that this could be achieved. For example, where the main body 100 or 1100 is manufactured from a soft and deformable material, a user may apply one or more squeezing forces to the bottle, such as by gripping the exterior of the main body in their hands and compressing the main body with opposing inwardly directed forces on the side surface of the main body. Due to the deformable nature of the main body, this would cause deformation of the bottle, thereby reducing the volume of the internal cavity (or central cavity) of the bottle device. In some embodiments the main body 100 or main body 1100 may be made from a material that is elastically deformable. The result will be that after the main body has been squeezed, to reduce the volume of interior cavity and propel liquid and a pill out of the bottle through the channel of the pill straw, then once the squeezing force(s) are released, then air may enter into the top end of channel and pass through the bottom end of the channel and into the interior cavity of the bottle. The elastic nature of the material may then permit the bottle to change back to its initial configuration/shape.

In some embodiments the main body may be made from plastics, including, but not limited to a polyester (in particular polyethylene terephthalate, PET (or PETE), polybutylene terephthalate, PBT, polyethylene naphthalate, PEN, polylactic Acid, PLA, polyhydroxybutyrate and their copolymers), polyamide (in particular PA 6, PA 6.6, PA 6.10, PA 6.12, PA 11, PA 12 and their copolymers), polyethylene (PE) in all its variations, based on density, molecular weight or branching (for example: low (LDPE), medium or high (HDPE) density, linear or branched, high, ultra-high, low, ultra-low molecular weight and all their combinations), polypropylene, polycarbonate (PC), polystyrene (PS), polymethylmethacrylate (PMMA, including its modifications with comonomers such as methacrylic acid, acrylate, butyl acrylate), acrylonitrile butadiene styrene (ABS), polyvinylchloride, polyether sulfone, polyetherether ketone, polyetherimide, polyphenyleneoxide and other less common grades of plastic sheets or film. In other embodiments, the main body may be made from silicone.

In some embodiments, main body lid (102 or 1102) may be made from the same material as the main body or from a different material. In an embodiment, the main body lid is made from a harder plastic (i.e., a plastic having increased rigidity or stiffness) in comparison to the main body.

In some embodiments, the pill straw (152 or 1152) may be made from the same material as the main body or from a different material. In various embodiments the pill straw is made from polyethylene terephthalate (PET), high density polyethylene (HDPE) or low density (LDPE).

In some embodiments, the process of inserting a pill into the channel and then squeezing the bottle to eject liquid and a pill into a user's/patient's mouth, may be repeated in order to deliver a plurality of pills into succession into user's mouth. In other embodiments, more than one pill may be inserted into the channel at the same time, and then by squeezing the bottle ejects liquid and the plurality of pills substantially at the same time, in order to deliver a plurality of pills into succession into user's/patient's mouth at substantially the same time.

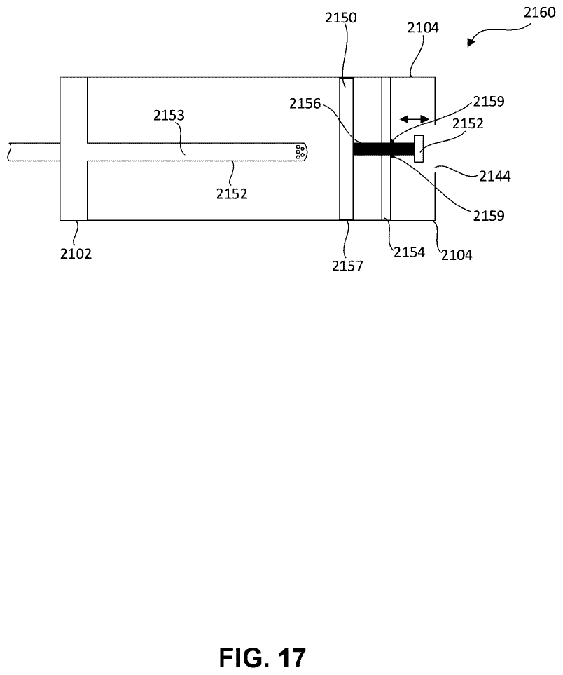

In other embodiments, instead of main body 100 or 1100 being squeezable, the internal volume of the internal cavity of main body may be reduced in another way. For example, with reference to FIG. 17, an alternate embodiment of a bottle device is depicted schematically, such bottle device being substantially the same as the bottle device of FIG. 16 as referenced above and having a main body and lid 2152. However, at the lower region of the main body of this bottle device may be an alternative suitable volume reduction mechanism such as a plunger/piston mechanism generally designated 2160 which may be housed within or interconnected to the lower region of the main body. The plunger mechanism 2160 may be mounted to/be formed at, the bottom region of the main body and may be configured with and be operable to have an internal piston 2150 housed in the main body and sealed with a sealing device 2157 such as an o-ring, at its circumferential edge to an interior circular cylindrical surface of the main body. The inner surface of piston 2150 may define the bottom wall of the internal cavity of the main body. Therefore, as the axial position of the piston 2150 changes, so does the volume of the internal cavity. A piston rod 2156 may extend through a generally circular lower wall 2154 of the main body and be sealed between and with the lower wall with a seal device 2159. Piston rod 2156 that can be moved inwardly (and optionally outwardly) by a user applying an axial compressive force to a plate 2152 that is accessible (such as with an operator's fingers) through an opening 2144 in bottom support wall 2104 in main body. An operator can push inwardly in an axial direction on the plate 2152 that is secured to piston rod 2156 through the opening 2144, in order to apply an axial compressive force. This causes piston 2150 to compress the liquid within the internal cavity of the main body, and thereby decrease the volume of the internal cavity of main body as the piston 2150 is moved axially inwardly, thereby propelling the liquid along with the pill through the channel 2153 of pill straw 2152 to exit from the opening and into a user's/patient's mouth. The user/patient may swallow the pill and liquid simultaneously and thereby transferring the pill to the user's stomach. An operator may thereafter pull axially on plate 2152 in order to increase the volume of the internal cavity in the main body. This may then allow air and/or more liquid to be inserted into the internal cavity such as air passing from the upper opening of channel 2153 into the internal cavity. Also, the lid may be removed from main body to allow replenishment of liquid into the internal cavity.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

What is claimed is:

1. A method of transferring a pill from a bottle device to a user's stomach:
wherein the bottle device comprises:
(i) a main body enclosing an internal cavity, said main body being deformable upon the application of one or more squeezing forces to reduce a volume of said internal cavity;
(ii) a lid portion secured to the main body;
(iii) a pill straw secured to the main body lid, said pill straw comprising a channel having an upper opening at an upper end through which a pill can be placed, and further comprises a plurality of pill straw inlets proximate a lower end of said channel, said pill straw inlets sized to hold the pill within the channel;
wherein the method comprises:
(a) inserting a pill into the upper opening of the pill straw and into the channel, with the internal cavity containing a volume of liquid;
(b) placing a user's lips over the upper opening of the pill straw; and
(c) applying one or more squeezing forces to the main body to reduce the volume of the internal cavity of the device to propel a liquid located within the internal cavity through the plurality of pill straw inlets and propel the liquid along with the pill through the channel to exit from the opening and into a user's mouth, whereby the user swallows the pill and liquid simultaneously, thereby transferring the pill to the user's stomach.

2. The method of claim 1, wherein the pill straw further comprises a pill straw spout at the upper end of the channel when the main body of the device is squeezed the liquid is also propelled through the pill straw spout.

3. The method of claim 1 wherein before (c), with the bottle held upright, the user tilts their head downwards.

4. The method of claim 1, wherein the pill straw is reversibly secured to the main body lid.

5. The method of claim 1 further comprising before step (b) inserting said volume of liquid into the internal cavity.

6. The method of any one of claims 1 to 5 where the channel has an interior diameter in the range of 0.5 to 1.0 cm.

7. The method of any one of claims 1 to 6 where the internal cavity has a volume of about 600 cm3.

8. The method of any one of claims 1 to 7 wherein during operation the liquid along with the pill exit from the opening in a stream or jet of liquid.

9. A swallowing assist bottle device, comprising:
(a) a main body enclosing an internal cavity, said main body being deformable upon the application of one or more squeezing forces to reduce a volume of said internal cavity;
(b) a lid portion secured to the main body;
(c) a pill straw secured to the main body lid, said pill straw comprising a channel having an upper opening at an upper end through which a pill can be placed, and further comprises a plurality of pill straw inlets proximate a lower end of said channel, said pill straw inlets sized to hold the pill within the channel;
wherein in operation, when a liquid is inserted into the internal cavity, and a user's lips are placed over the upper opening of the pill straw; applying one or more squeezing forces to the main body of the device reduces the volume of the internal cavity to propel a liquid located within the internal cavity through the plurality of pill straw inlets and propel the liquid along with the pill in the channel, through the channel to exit from the upper opening and into a user's mouth, whereby the user swallows the pill and liquid simultaneously, thereby transferring the pill to the user's stomach.

10. The device of claim 9, wherein the pill straw further comprises a pill straw spout at the upper end of the channel when the main body of the device is squeezed the liquid is also propelled through the pill straw spout.

11. The device of claim 9, wherein the pill straw spout is reversibly deployable into a straw spout recess in the lid portion.

12. The device of claim 9, wherein the pill straw is reversibly secured to the main body lid.

13. The device of claim 9 wherein the main body is made from a deformable plastic.

14. The device of any one of claims 9 to 12 wherein the main body is made from at least one of the following materials: silicone, polyethylene terephthalate (PET), high density polyethylene (HDPE) or low density polyethylene (LDPE).

15. The device of and one of claims 9 to 14 wherein the lid portion is made from a hard plastic.

16. The device of any one of claims 9 to 15 wherein the pill straw is made from silicone, polyethylene terephthalate (PET), high density polyethylene (HDPE) or low density polyethylene (LDPE).

17. The device of any one of claims 9 to 16 wherein the pill straw is secured to the main body lid with a sealing mechanism.

18. The device of claim 17 where the securing mechanism comprises a rubber seal device.

19. The device of any one of claims 9 to 18 wherein the pill straw comprises a lower region surface area proximate the lower end of the channel and wherein the area of the plurality of pill straw inlets comprise at least 50% of the lower surface region area.

20. The device of any one of claims 9 to 19 where the channel has an interior diameter in the range of 0.5 to 1.0 cm.

21. The device of any one of claims 9 to 20 where the internal cavity has a volume of about 600 cm³.

22. The device of any one of claims 9 to 21 wherein during operation the liquid along with the pill exit from the opening in a stream or jet of liquid 23. A swallowing assist bottle device, comprising:
(a) a main body enclosing an internal cavity;
(b) a lid portion secured to the main body;
(c) a pill straw secured to and extending through the main body lid, said pill straw comprising a channel having an upper opening at an upper end through which a pill can be placed, and further comprises a plurality of pill straw inlets proximate a lower end of said channel, said pill straw inlets sized to hold the pill within the channel;
(d) a volume reduction mechanism operable to reduce the volume of the internal cavity of the main body;
wherein in operation, when a liquid is inserted into the internal cavity, and a user's lips are placed over the upper opening of the pill straw; operating the volume reduction mechanism reduces a volume of the internal cavity to propel a liquid located within the internal cavity through the plurality of pill straw inlets and propel the liquid along with the pill in the channel, through the channel to exit from the upper opening and into a user's mouth, whereby the user swallows the pill and liquid simultaneously, thereby transferring the pill to the user's mouth.

24. A device as claimed in claim 23 wherein the volume reduction mechanism comprises said body being constructed in a manner that one or more sides of the main body can be squeezed inwards to reduce said volume upon application of one or more squeezing forces.

25. A device a claimed in claim 23 wherein the volume reduction mechanism comprises a plunger device mounted at a bottom end of said main body, said plunger device operable to move a piston within said internal cavity to reduce said volume.

26. The device of any one of claims 23 to 25 wherein the main body is made from at least one of the following materials: silicone, polyethylene terephthalate (PET), high density polyethylene (HDPE) or low density polyethylene (LDPE).

27. The device of and one of claims 23 to 26 wherein the lid portion is made from a hard plastic.

28. The device of any one of claims 23 to 27 wherein the pill straw is made from silicone, polyethylene terephthalate (PET), high density polyethylene (HDPE) or low density polyethylene (LDPE).

29. The device of any one of claims 23 to 28 wherein the pill straw is secured to the main body lid with a sealing mechanism.

30. The device of claim 29 where the securing mechanism comprises a rubber seal device.

31. The device of any one of claims 23 to 30 wherein the pill straw comprises a lower region surface area proximate the lower end of the channel and wherein the area of the plurality of pill straw inlets comprise at least 50% of the lower surface region area.

32. The device of any one of claims 23 to 31 where the channel has an interior diameter in the range of 0.5 to 1.0 cm.

33. The device of any one of claims 23 to 32 where the internal cavity has a volume of about 600 cm³.

34. The device of any one of claims 23 to 33 wherein during operation the liquid along with the pill exit from the opening in a stream or jet of liquid

35. A method of using any of the devices of claims 23 to 34 comprising:
(a) inserting a pill into the upper opening of the pill straw and into the channel, with the internal cavity containing a volume of liquid;
(b) placing a user's lips over the upper opening of the pill straw; and
(c) activating the volume reduction mechanism to reduce the volume of the internal cavity of the device to propel a liquid located within the internal cavity through the plurality of pill straw inlets and into the channel to propel the liquid along with the pill through the channel to exit from the opening and pass into a user's mouth.

36. The method of claim 35 wherein before (c), with the bottle held upright, the user tilts their head downwards.
